(19) United States
(12) Patent Application Publication
(10) Pub. No.: US 2008/0307912 A1
(43) Pub. Date: Dec. 18, 2008

(54) Transmission assembly and straightening machine for same

(75) Inventors: Bernhard Schafer, Neuried (DE); Wolfgang Leser, Lahr (DE)

Correspondence Address: COLLARD & ROE, P.C., 1077 NORTHERN BOULEVARD, ROSLYN, NY, 11576, US

(73) Assignee: Kohler Maschinenbau GmbH

(21) Appl. No.: 12/156,492

(22) Filed: Jun. 2, 2008

(30) Foreign Application Priority Data
Jun. 15, 2007 (DE) 20 2007 008 589.3

(51) Int. Cl. F16H 37/00

(52) U.S. Cl. 74/11

(57) ABSTRACT

A transmission assembly, particularly for a straightening machine, has a least one drive and a number of power take-offs, which stand in an effect connection with the drive for a transfer of torque. At least one power take-off is coupled with a torque monitoring device independent of other power take-offs to monitor a power take-off moment that is in effect at the power take-off in question. The torque monitoring device is configured as a function of a result of the power take-off monitoring. The transmission assembly may be connected with a torque transfer mechanism, particularly articulated shafts, of a straightening machine for straightening materials, particularly in plate or strip form, having an arrangement of straightening rollers between which the material to be straightened is conveyed and which are driven by way of the torque transfer mechanism.

### CROSS REFERENCE TO RELATED APPLICATIONS

Applicants claim priority under 35 U.S.C. §119 of German Application No. 20 2007 008 589.3 filed Jun. 15, 2007.

### BACKGROUND OF THE INVENTION

1. Field of the Invention

The present invention relates to a transmission assembly, particularly for a straightening machine, having at least one drive having a number of power take-offs, which stand in an effect connection with the drive, for a transfer of torque.

Furthermore, the present invention relates to a straightening machine for straightening materials, particularly in plate or strip form. The machine has an arrangement of straightening rollers, between which the material to be straightened is conveyed, and which are driven by way of articulated shafts, which are connected with a transmission assembly.

2. The Prior Art

In industrial practice, certain materials, such as sheet metals or the like, are preferably kept on hand in a rolled-up state, in the form of so-called coils. Before they are processed further, it is generally necessary, in this connection, to straighten the material after it is unwound from the coil, in other words to make it flat again or smooth. For this purpose, straightening machines are used, in which the material to be straightened is conveyed between straightening rollers, between which the material is deformed, so that it leaves the straightening section of the straightening machine that comprises the straightening rollers in essentially smooth (planar) form, in other words in straightened form.

As was stated initially, a straightening machine has a transmission assembly for this purpose, in which the torque supplied by a drive is distributed among a number of power take-offs, which are connected with the straightening rollers by way of articulated shafts, in order to drive these rollers for conveying and deforming the material.

The articulated shafts used in this connection are often the weakest link of such a straightening machine. During their operation, it can happen, during the course of problems in operation, that highly excessive torques are in effect at individual power take-offs, and thus at the related articulated shafts, and these torques can lead to damage or even destruction of the corresponding articulated shafts. This damage or destruction makes a complicated repair of the straightening machine necessary, and furthermore causes additional costs due to the machine downtime. Disruptions in operation that can have such a destructive effect on the articulated shafts of the straightening machine occur due to a number of reasons. Among other things, such disruptions occur due to drawing a multiple material layer, particularly a double material layer, into the straightening section, due to contamination or damage of the material to be straightened, as well as due to built-up rocking of the system of drive, power take-offs, articulated shafts, and straightening rollers, which system is capable of vibration, and which can surprisingly lead to greatly excessive torques that have not been possible to control until now.

For this reason, it is known to convert an effective power take-off torque into an axial movement that represents a measure for the torque, on a distributor wheel of the transmission assembly, by way of interacting helical gears. In this connection, the axial movement takes place counter to a spring bias, so that when a specific limit load is exceeded, the straightening machine is shut down by means of closing a corresponding contact. It is a disadvantage of this solution that only the sum torque of a plurality of power take-offs, particularly four to five power take-offs, is measured at the distributor wheel. The vibration behavior of the straightening machine, however, brings with it the result that the individual torques at the individual articulated shafts or power take-offs are sometimes significantly higher than the monitored sum torque at the distributor wheel. Therefore, reliable shutdown of the straightening machine is hardly possible according to this prior art.

Alternative solution paths use indirect torque monitoring via expansion measurement strips or torsion shafts on the articulated shafts themselves, which brings with it the corresponding costs. In addition, the use of slip clutches is also known, but these slip clutches are subject to wear, which is a disadvantage.

### SUMMARY OF THE INVENTION

It is an object of the invention to provide a transmission assembly and a straightening machine of the respective type indicated initially, with which or in the case of which reliable overload security can be achieved, in order to avoid repair costs and machine downtime, particularly in the case of the disruptions in operation indicated above.

These and other objects are achieved by a transmission assembly according to one aspect of the invention and by a straightening machine according to another aspect of the invention. Advantageous further developments are discussed below.

According to a first aspect of the present invention, a transmission assembly, particularly for a straightening machine, has at least one drive and a number of power take-offs, which stand in an effect connection with the drive for a transfer of torque. At least one power take-off is coupled with a torque monitoring device, independent of other power take-offs, to monitor a power take-off moment that is in effect at the power take-off in question. The torque monitoring device is configured to output a control signal as a function of a result of the power take-off moment monitoring.

The torque monitoring device may include a pressure sensor, such as a load cell for generating the control signal. The control signal may be a shutdown signal for an overriding drive unit, if the result of the power take-off moment monitoring indicates that a predetermined limit value, particularly a load limit value of a torque transfer means coupled with the power take-off in question, particularly an articulated shaft, has been exceeded.

The power take-off in question may have a measurement power take-off shaft which is mounted to be movable in the axial direction, as a function of the power take-off moment in effect. The axial movement of the measurement power take-off shaft is a measure for the effective power take-off moment.

The measurement power take-off shaft may be disposed as an inside shaft in a hollow-shaft, whereby the follow shaft is coupled both with the drive and with other power take-offs of the transmission assembly for a transfer of torque.

The axial movement of the measurement power take-off shaft may be brought about by means of interaction of a helically geared gear wheel disposed on the measurement power take-off shaft having a first pitch direction with a helically geared gear wheel coupled with the drive having a second pitch direction complementary to the first pitch direction.

The measurement power take-off shaft may be directly coupled with the drive, and no other power take-off shafts may be coupled with the measurement power take-off shaft. The measurement power take-off shaft may be disposed offset relative to a plane that contains the other power take-off shafts, particularly offset parallel.

According to another aspect of the present invention, a straightening machine for straightening materials, particularly in plate or strip form, has an arrangement of straightening rollers, between which the material to be straightened is conveyed, and which are driven by way of torque transfer means, particularly articulated shafts, which are connected with a transmission assembly. The transmission assembly is configured in accordance with the first aspect of the present invention.

A drive unit of the straightening machine coupled with the transmission assembly may be controlled by the control signal generated by the transmission assembly.

The straightening rollers may be arranged in groups, with parallel roller axes within a group, in each instance, whereby the roller axes of straightening rollers of one group, in each instance, are disposed essentially in a common plane, and whereby the n^{th} straightening roller in the transport direction of the material to be straightened is driven by the power take-off shaft of the transmission assembly that is configured as a measurement power take-off shaft. Preferably, n=2 and/or 5, or n=3. An m^{th} straightening roller in the transport direction of the material to be straightened may be disposed offset relative to the other straightening rollers of its group, particularly offset parallel. Preferably, m=2.

According to an embodiment of the present invention, the at least one monitored power take-off of the transmission assembly is uncoupled from other power take-offs of the same, in order to measure the effective torque at the one power take-off, independent of the other power take-offs, while conventionally, only the sum of effective power take-off moments is measured.

In another embodiment of the invention, the transmission assembly (distributor transmission) has a helical gear on at least one power take-off. In this way, a torque that is in effect there is proportional to an axial force that occurs, which force is particularly measured by means of a load cell. The corresponding power take-off shaft therefore functions as a measurement shaft or measurement power take-off shaft, and is mounted in an effect connection with a corresponding pressure measurement device, for example a load cell, whereby the mounting demonstrates axial play.

In the case of a special embodiment of the invention, mounting of the measurement power take-off shaft takes place by way of roller bearings, for example by a combination of an axial bearing with a radial bearing independent of it for supporting the measurement power take-off shaft, so that axial bearing and radial bearing are separate, and the axial movement can take place without being influenced.

According to another embodiment of the present invention, the straightening machine has an arrangement of straightening rollers, which are disposed essentially in two planes, in the form of a roller frame, which two planes run at a finite angle relative to one another. A material to be straightened is conveyed between these two straightening roller planes, whereby in a further development of the present invention, it is advantageous if the second and fifth rollers, in the transport direction of the material to be straightened, are monitored with regard to the torque that acts on them, i.e. on a related articulated shaft. Experience has shown that the fifth straightening roller is subject to the greatest stress, because the greatest deformation work is carried out here, while normally, hardly any reverse torque occurs at the second roller, particularly because the first to third straightening rollers are set against the material only lightly, in order to guarantee problem-free run-in of the material to be straightened into the straightening section. At the second straightening roller in the transport direction of the material to be straightened, however, increased torque particularly occurs if more than only one layer of the material to be straightened is drawn in by mistake. Monitoring of the torque at this roller, i.e. at the related power take-off, can therefore be used for shutdown to protect against double sheets.

The above statements relate to a straightening roller arrangement in which the second roller is offset relative to the other rollers of the corresponding roller plane. If, however, the second roller is not offset, a corresponding embodiment of the present invention provides that, the third roller in the transport direction is monitored in place of the fifth one.

If a possible overload of the related articulated shaft is recognized on the basis of the axial movement of a measurement power take-off shaft, the related torque monitoring device preferably generates a control signal, by which the straightening machine, particularly a drive unit of this machine, is immediately shut down. In this way, an overload cause can be corrected before damage to articulated shafts occurs, which is complicated to repair.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a schematic block diagram of a straightening machine according to the invention;

FIG. 2 is a schematic front view of a straightening section of the straightening machine in FIG. 1;

FIG. 3 is a first front view of a transmission assembly of the straightening machine in FIG. 1;

FIG. 4 is a section along the line A-A in FIG. 3;

FIG. 5 is an enlarged detail representation of FIG. 4;

FIG. 6 is a section along the line B-B in FIG. 3;

FIG. 7 is a section along the line C-C in FIG. 3;

FIG. 8 is a first partial view to show the coupling of drive and power take-offs in the case of the transmission assembly according to FIG. 3 to FIG. 7;

FIG. 9 is another schematic representation of the coupling relationships of drive and power take-offs in the case of the transmission assembly according to FIG. 3 to FIG. 7; and

FIG. 10 a side view of the transmission assembly in FIG. 1.

### DETAILED DESCRIPTION OF PREFERRED EMBODIMENTS

Referring now in detail to the drawings and in particular, FIG. 1 shows a straightening machine 1, using a schematic block diagram. Straightening machine 1 comprises a drive unit 2, a transmission assembly 3, and a straightening section 4. Transmission assembly 3 has a drive 5, which is connected with drive unit 2 of straightening machine 1 by way of suitable connection means 6, particularly a shaft. In a mechanical effect connection or coupling with drive 5, the transmission assembly 3 has a number of power take-offs 7.1, . . . , 7.n, at which a torque made available by drive unit 2, by way of drive 5 of transmission assembly 3, can be tapped—if necessary after suitable step-up or step-down. Each of power take-offs 7.1, . . . , 7.n is connected with a corresponding straightening roller 9.1, . . . , 9.n of straightening section 4, which is accordingly configured as a roller frame, by way of an assigned connection means in the form of an articulated shaft 8.1, . . . , 8.n.

Most of power take-offs 7.1, . . . of transmission assembly 3 are coupled with one another in the manner of a cascade to distribute the torque supplied by drive unit 2. The second and the fifth power take-offs 7.2 and 7.5, respectively, of transmission assembly 3, however, are directly coupled with drive 5, and have no other power take-offs of any kind, either switched in parallel and/or following. In other words, power take-offs 7.2, 7.5 are independent of the other power take-offs of transmission assembly 3.

The second and fifth power take-offs 7.2, 7.5 of transmission assembly 3 stand in an effect connection with a torque monitoring device 10.2 or 10.5, respectively, that is assigned to them, in each instance, as is symbolized in FIG. 1 with broken lines. Torque monitoring devices 10.2, 10.5 are in turn connected with drive unit 2, in terms of control technology.

Torque monitoring devices 10.2, 10.5 are configured to monitor power take-offs 7.2, 7.5 of transmission assembly 3, which are independent, as explained above, for the occurrence of very high or excessive torques, which could, under some circumstances, lead to destruction of corresponding articulated shafts 8.2, 8.5. If one of torque monitoring devices 10.2, 10.5 recognizes the occurrence of such a torque, it generates a corresponding control signal SS2 or SS5, respectively, which is used, according to the present embodiment, to control drive unit 2, particularly to shut it down immediately. In particular, the control signal SS2, SS5 is generated by torque monitoring device 10.2 or 10.5 in question, if the value of the currently effective torque measured for the corresponding articulated shaft exceeds the decisive maximal value for the torque (power take-off moment). In this connection, possible disruptions in operation comprise, in particular, simultaneously drawing a plurality of materials 11 to be straightened into straightening section 4, contamination of or damage to material 11 to be straightened, as well as built-up rocking of the system of drive 5, power take-offs 7.1, of transmission assembly 3, articulated shafts 8.1, . . . , and straightening rollers, which system is capable of vibration, whereby extremely high torques can occur at individual straightening rollers 9.1, . . . or the related articulated shafts 8.1, . . . , respectively, which can possibly cause damage to articulated shafts 8.1, . . . .

In order to counteract or avert such damage, selected power take-offs 7.2, 7.5 of transmission assembly 3, which are uncoupled from the other power take-offs, to the greatest possible extent—as already briefly mentioned—stand in connection with torque monitoring devices 10.2, 10.5, which generate the appropriate control signal SS2, SS5 if a permissible maximal torque for the articulated shafts 8.2, 8.5 in question is exceeded, thereby bringing about shutdown of drive unit 2 immediately, so that no damage to straightening machine 1 can occur, particularly in the region of articulated shafts 8.1, . . . . Because, in the present case, those power take-offs 7.2, 7.5 of transmission assembly 3 that are essentially uncoupled from the other power take-offs of transmission assembly 3 are being monitored, very precise, targeted, and reliable overload shutdown of straightening machine 1 can be achieved.

The specific circumstances for the selection of the second and fifth power take-offs 7.2, 7.5 of transmission assembly 3, in the transport direction F, for the torque monitoring, will be discussed in greater detail farther below.

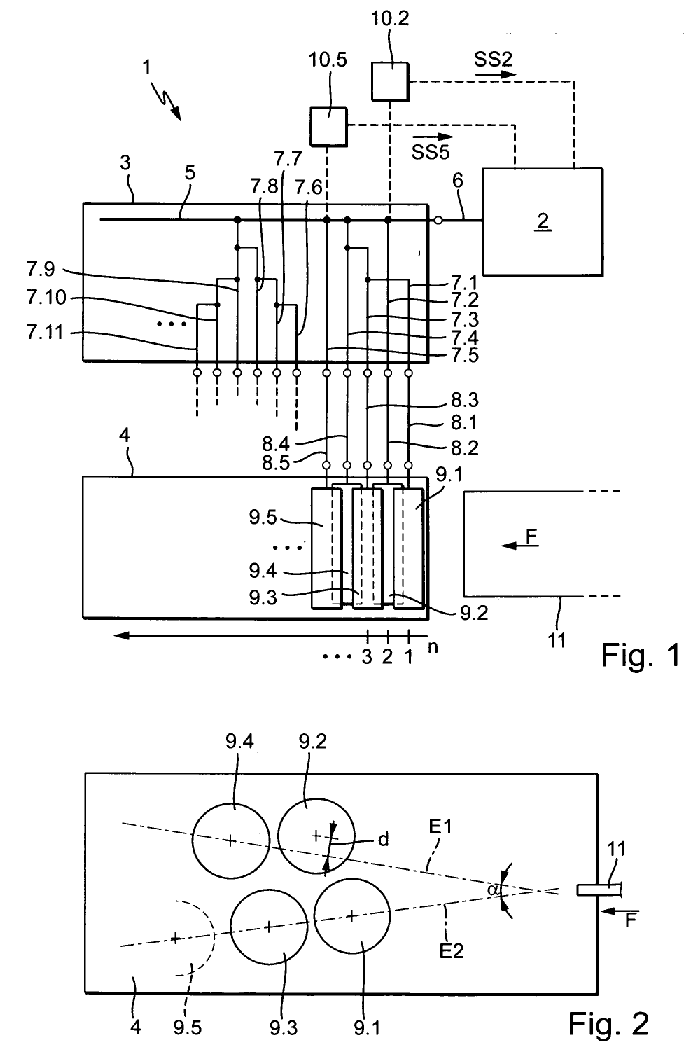

FIG. 2 shows a schematic front view of the straightening section 4 in FIG. 1. As can be seen in the representation according to FIG. 2, the straightening rollers 9.1, are disposed in two groups, with parallel roller axes, by group, in each instance, whereby the roller axes of one group lie in a common plane, in each instance. In the present case, the plane E1 refers to the common straightening roller plane of the even straightening rollers 9.4, 9.6, . . . , in transport direction F, while the plane E2 refers to the roller axis plane of the odd straightening rollers 9.1, 9.3, . . . in transport direction F. Planes E1 and E2 enclose a finite angle α, which is also referred to as a setting angle.

As is furthermore evident from the representation in FIG. 2, the second straightening roller 9.2 in transport direction F is disposed so that it is displaced upward and parallel by a dimension d, relative to plane E1.

The straightening rollers 9.1, . . . of straightening section 4 serve in known manner to straighten material 11 that is being transported through straightening section 4, between the stated groups of rollers, in transport direction F. In this connection, the first to third straightening rollers 9.1-9.3, in transport direction F, essentially ensure problem-free intake of material 11 to be straightened into the straightening section, while the significant straightening work is carried out by the fourth and fifth straightening rollers 9.4, 9.5, in transport direction F.

In the case of the embodiment shown, the second and fifth straightening rollers 9.2 and 9.5, respectively, in other words the corresponding power take-offs 7.2 and 7.5, respectively, of transmission assembly 3 (cf. FIG. 1), are connected with corresponding torque monitoring devices. This selection is motivated by the hardly any torque experienced by the second straightening roller 9.2 in normal operation of the straightening machine; possibly harmful elevated torque occurs at this roller only if, in the present case, a double layer of the material 11, particularly a double sheet, is introduced into straightening section 4, for example. Corresponding torque monitoring at second straightening roller 9.2 therefore functions as protection against double sheets, for example, and assures shutdown of drive unit 2 of straightening machine 1, if necessary (cf. FIG. 1), before damage occurs to the same. Experience has shown that the fifth straightening roller 9.5 in transport direction F is under the greatest stress during the straightening process, because the greatest deformation work occurs here. For this reason, torque monitoring in connection with this roller continues to be particularly well suited for guaranteeing reliable operation of the straightening machine according to the invention, particularly in case of incorrect settings of the roller adjustment by the operator, and when using overly great straightening cross-sections.

If second straightening roller 9.2 is not offset upward, in contrast to the embodiment of FIG. 2, an alternative embodiment monitors the third straightening roller 9.3, i.e. the related power take-off 7.3 (cf. FIG. 1) of transmission assembly 3, in place of the firth and/or second straightening roller 9.5 and 9.2, respectively.

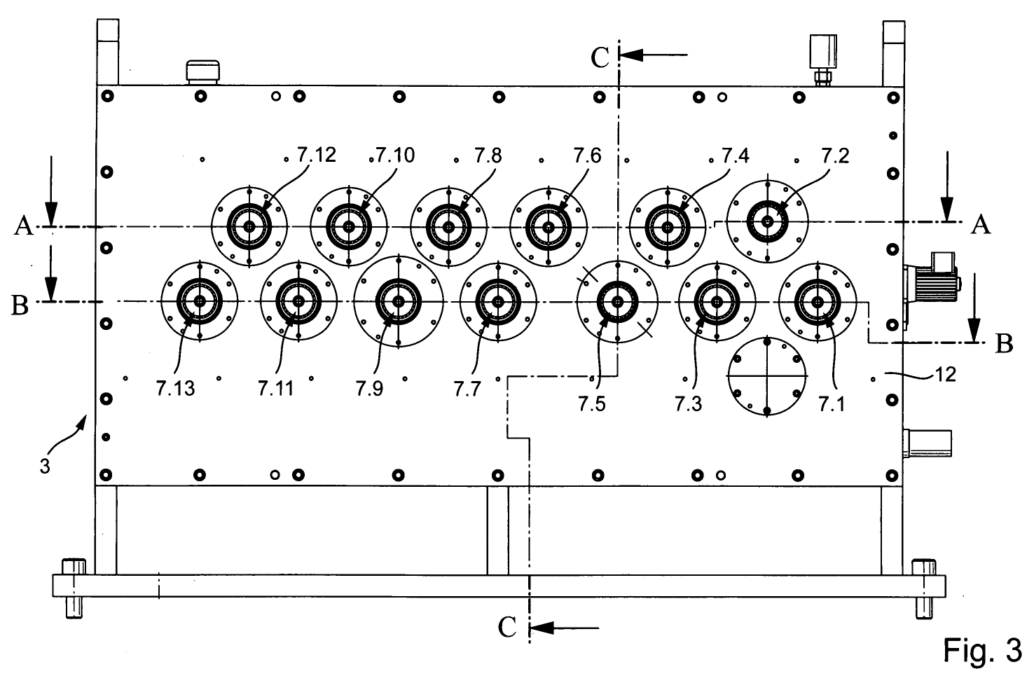

FIG. 3 shows a front view of transmission assembly 3 of FIG. 1. Transmission assembly 3 has a housing 12 from which the power take-offs 7.1, . . . for connecting the related articulated shafts 8.1, . . . (cf. FIG. 1) project. For this purpose, power take-offs 7.1, . . . have suitable connectors or connection means, which are not explicitly designated in FIG. 3.

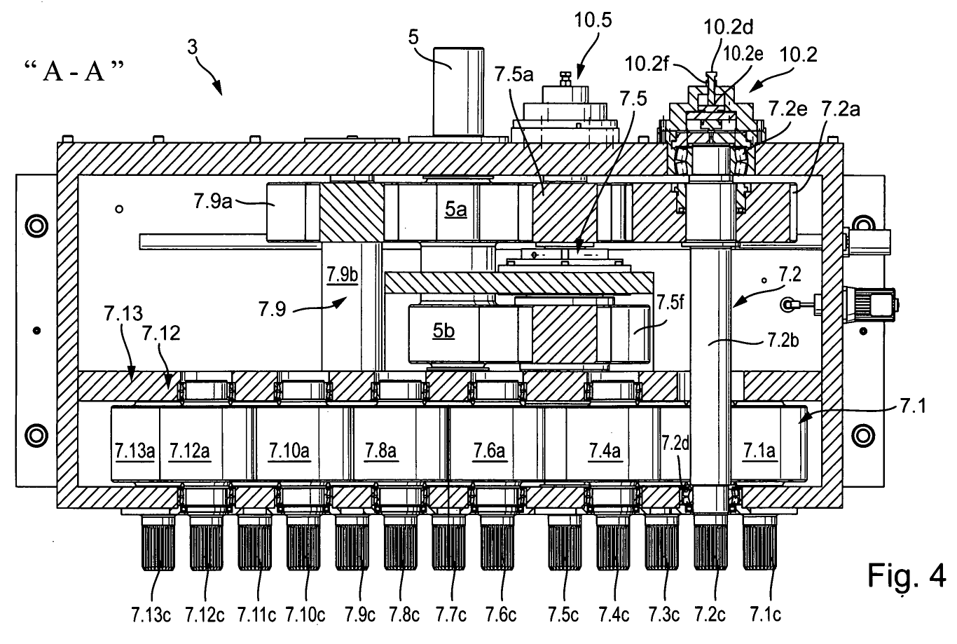

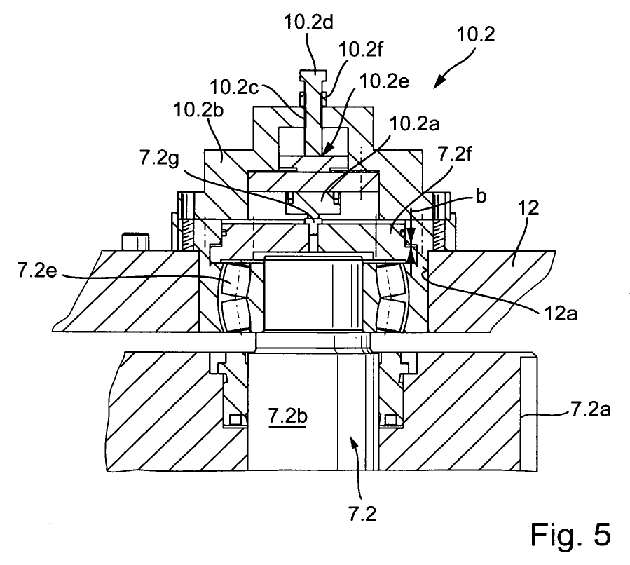

FIG. 4 shows a section along the line A-A in FIG. 3. Drive 5, i.e. a corresponding drive shaft, has a first gear wheel 5a, which, in the present case, has an outer helical gearing, for example with a left pitch. This gear wheel stands in engagement with a first gear wheel 7.5a on the fifth power take-off 7.5, i.e. on a corresponding power take-off shaft. Gear wheel 7.5a accordingly has an outer helical gearing that is complementary to that of gear wheel 5a, for example in the form of a right pitch. Gear wheel 7.5a stands in engagement with a gear wheel 7.2a of the second power take-off 7.2, i.e. a corresponding power take-off shaft 7.2b, which again is complementary. This shaft has suitable connection means 7.2c for connecting the related articulated shaft 8.2 (cf. FIG. 1) at its first free end, which projects out of housing 12 of transmission assembly 3. Furthermore, the power take-off shaft 7.2b is mounted by means of roller bearings 7.2d, 7.2e, so that it is movable in the axial direction, by a certain dimension (cf. FIG. 5). A corresponding axial movement is brought about during operation of transmission assembly 3 by means of drive 5, on the basis of the helically geared coupling, and is a measure of the torque in effect for power take-off 7.2, which might lead to damage of corresponding articulated shaft 8.2 if it exceeds a certain maximal value.

In order to prevent this damage, a torque monitoring device 10.2 (cf. FIG. 1) is provided on power take-off 7.2 in the region of the other end of power take-off shaft 7.2b. This device will be explained in greater detail below, making reference to the detailed detail enlargement in FIG. 5.

In the present case, it should still be pointed out that according to the representation in FIG. 4, no further power take-off trains are coupled with the monitored power take-off 7.2, so that a measured axial movement of power take-off shaft 7.2b indicates the torque in effect at power take-off 7.2, independent of the torques of other power take-offs of transmission assembly 3.

FIG. 5 shows a detail enlargement of the torque monitoring device 10.2 of the second power take-off 7.2 shown in FIG. 4. To accommodate the upper bearing 7.2e, housing 12 has an opening 12a. Above this bearing 7.2e, a part 7.2f that is mounted to be movable in the axial direction of power take-off shaft 7.2b is disposed, the upward mobility of which part is limited to a dimension b by means of complementary set-back structures on an outer part of the bearing 7.2e and on the movable part 7.2f itself. Above the movable part 7.2f, a load cell 10.2a is disposed, on which the movable part 7.2f acts during its axial movement, by means of a punch-shaped projection part 7.2g on its top. A bore 10.2c is provided in the upper region of the cover 10.2b, to brace the load cell 10.2a between the projection part 7.2g and an outer cover 10.2b of the torque monitoring device 10.2, into which bore a bias means 10.2d in the form of a screw is inserted and held in place in a position suitable for biasing the load cell 10.2a, by a securing means 10.2e in the form of a nut.

Load cell 10.2a generates a pressure measurement signal, as a function of the axial movement of power take-off shaft 7.2b, which signal can be used as a control signal SS2 to control drive unit 2 of straightening machine 1 according to the invention, according to FIG. 1. If the torque in effect at power take-off 7.2, in other words at power take-off shaft 7.2b, exceeds a permissible maximal value, load cell 10.2a yields a corresponding signal, according to FIG. 5, which can be used to shut down drive unit 2, in the form of control signal SS2 according to FIG. 1, before damage to straightening machine 1 occurs.

Torque monitoring device 10.2 can be adjusted so that first, the play of power take-off shaft 7.2b (measurement shaft) is taken out, by means of tightening screw 10.2d, for example with a tightening torque of 20 Nm. Subsequently, screw 10.2d is loosened again, and tightened only by hand. From this position, screw 10.2d is subsequently turned out again by a certain angle dimension, for example by approximately 20° counterclockwise, and fixed in place with the nut 10.2e in this position.

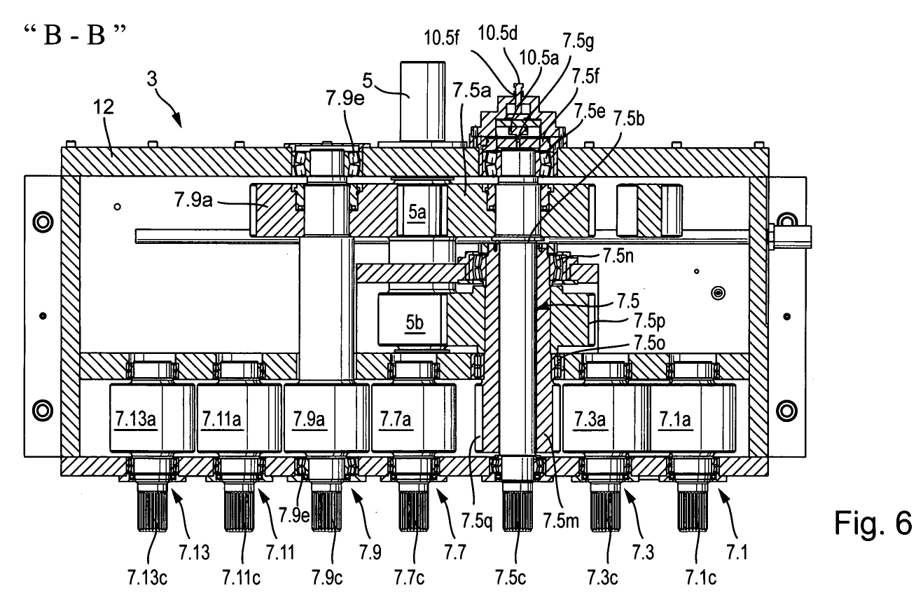

FIG. 6 shows a section along the line B-B in FIG. 3. In this connection, the configuration of transmission assembly 3 in the region of the fifth power take-off 7.5 is particularly shown. The fifth power take-off 7.5, analogous to the configuration of second power take-off 7.2 according to FIG. 4, has a power take-off shaft 7.5b mounted to move axially, at the one end of which a torque monitoring device 10.5 is disposed, which precisely corresponds, in terms of its structure, to what was described in detail above, using FIG. 5, for second power take-off 7.2, so that it is unnecessary to discuss details in this regard any further.

In the present case, only the additional characteristics of transmission assembly 3 in the region of fifth power take-off 7.5 will be described in detail. As can be seen in FIG. 6, the power take-off shaft 7.5b of fifth power take-off 7.5 is configured as an inner shaft that is disposed inside an outer hollow shaft 7.5m. Hollow shaft 7.5 m is mounted within housing 12 of transmission assembly 3 by means of roller bearings 7.5n, 7.5o, so that a rotation of inner power take-off shaft 7.5b and of outer hollow shaft 7.5 m can take place independent of one another. A first gear wheel 7.5p, particularly one with helical gearing, is disposed on outer hollow shaft 7.5m, and stands in engagement with a complementary gear wheel 5b of drive 5, i.e. a related drive shaft. Furthermore, outer hollow shaft 7.5m also has another, straight-geared gear wheel 7.5q, which couples directly or indirectly with corresponding gear wheels 7.3a, 7.1a of the third and first power take-offs 7.3 and 7.1, respectively.

Furthermore, FIG. 6 also shows a power take-off shaft 7.9c of the ninth power take-off 7.9, which has first and second gear wheels 7.9a and 7.9a′, respectively. The power take-off shaft 7.9b is also mounted to move axially, by way of roller bearings 7.9e. Gear wheel 7.9a is helically geared, and is configured to be complementary to gear wheel 5a of drive 5, with which it stands in a mechanical effect connection. Gear wheel 7.9a′ is configured with straight gearing, and couples mechanically, indirectly, with corresponding gear wheels 7.7a, 7.11a, 7.13a, of the seventh, eleventh, and 13^{th} power take-offs 7.7, 7.11, 7.13.

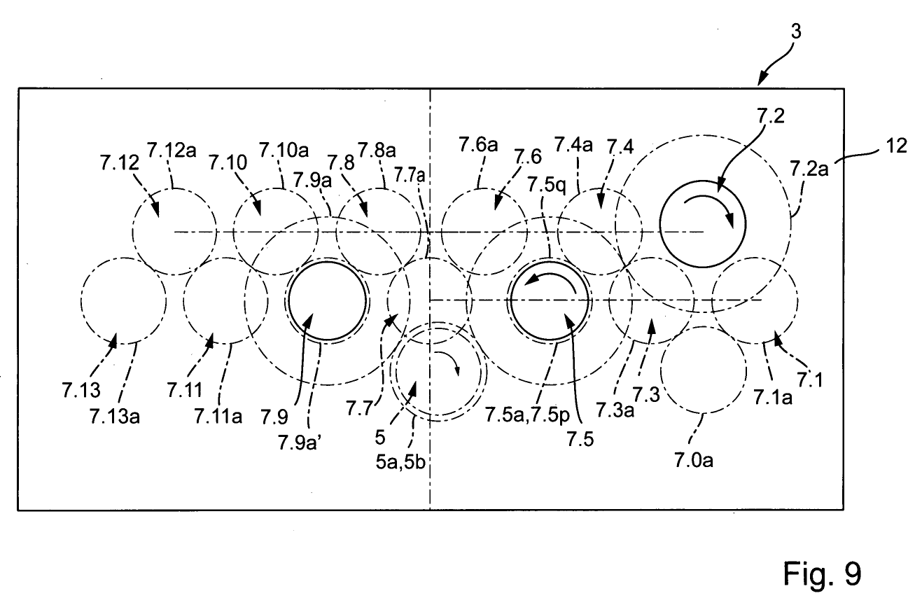

During operation of transmission assembly 3, i.e. of straightening machine 1 according to FIG. 1, drive 5 at first transfers a torque to power take-off 7.9, from which it is also distributed further to the other power take-offs 7.7, 7.11, and 7.13, in accordance with FIG. 6. As is particularly evident from the representation in FIG. 9, described farther below, further distribution of the torque to the power take-offs 7.6, 7.8, 7.10, and 7.12 also takes place; each of these power take-offs has corresponding straight-geared gear wheels, which interact directly and/or indirectly with gear wheels 7.7a, 7.9a′, 7.11a, and 7.13a shown in FIG. 6. Power take-offs 7.6-7.13 are thus coupled with one another; no torque monitoring takes place at them.

Furthermore, drive 5 acts on outer hollow shaft 7.5m of fifth power take-off 7.5, by way of gear wheels 5b and 7.5b; torque is distributed further to power take-offs 7.1 and 7.3 by way of gear wheel 7.5q of this power take-off. As is also evident from FIG. 9, further distribution of the torque to the power take-off 7.4 also takes place in this manner. Power take-off 7.4 also has a straight-geared gear wheel for this purpose, which interacts directly and/or indirectly with the gear wheels 7.5q, 7.3a, and 7.1a. In this manner, power take-offs 7.4, 7.3, and 7.1 are also mechanically coupled; no monitoring of torque takes place at them, either.

Independently, drive 5 also acts, by way of gear wheel 5a and gear wheel 7.5a, on inner power take-off shaft 7.5b of second power take-off 7.5, which, according to the invention, functions as a measurement power take-off shaft. In the region of this shaft, no further coupling with other power take-offs of transmission assembly 3 takes place, so that—as described in detail farther above—an independent torque monitoring can take place in the region of fifth power take-off 7.5 of corresponding articulated shaft 8.5 (cf. FIG. 1) and of related straightening roller 9.5, by way of the axial movement of measurement power take-off shaft 7.5b, which monitoring can be used to prevent an overload, according to the invention.

The same holds true, in accordance with the explanations relating to FIG. 5, in the region of second power take-off 7.2, whereby here, the torque is transferred from drive 5 to power take-off shaft 7.2b that functions as a measurement power take-off shaft, by way of gear wheels 5a, 7.5a, and 7.2a, independent of other power take-offs of transmission assembly 3. Here again, the axial movement of power take-off shaft 7.2b, which is independent of the other power take-offs of the transmission assembly, can be used to prevent an overload for straightening machine 1 according to the invention (as already described in detail above).

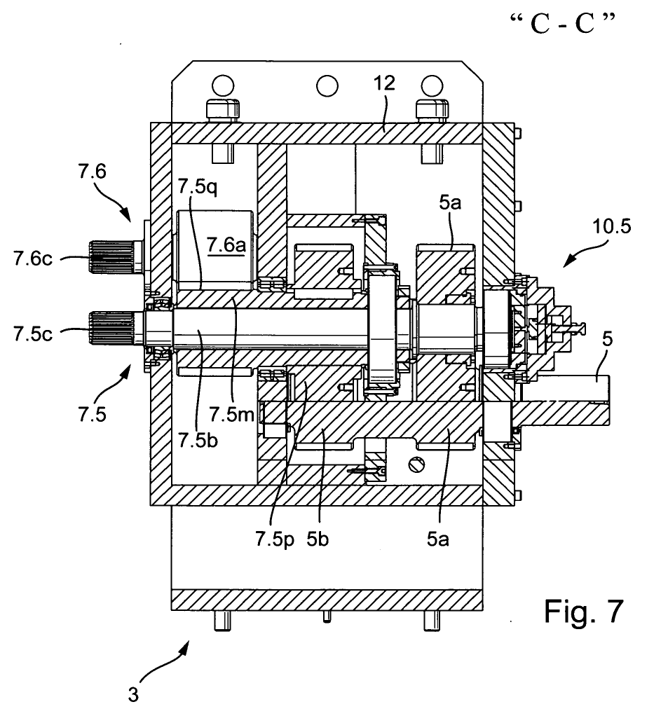

FIG. 7 shows a section along the line C-C in FIG. 3. In this connection, the same reference symbols refer to the same elements as already described in detail above on the basis of FIG. 3 to FIG. 6.

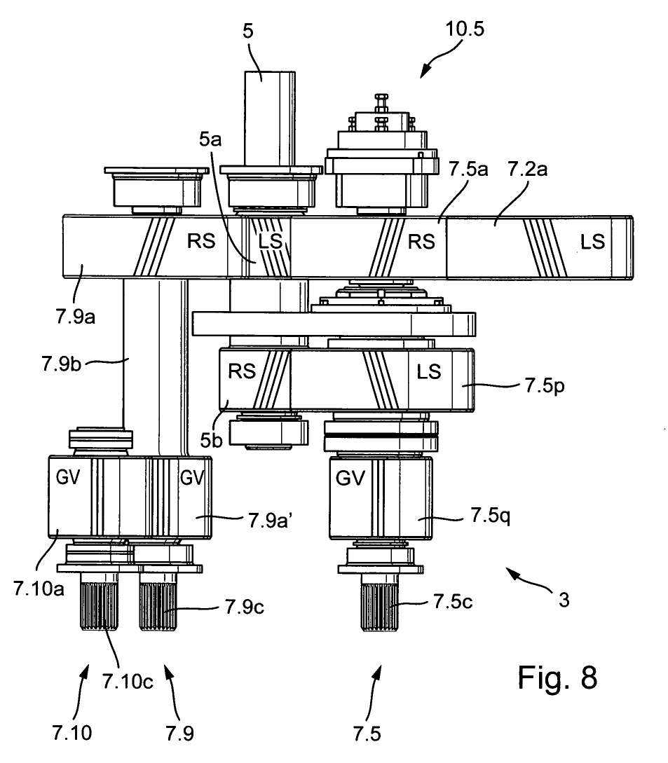

FIG. 8 once again shows the various coupling forms for torque transfer, using some selected components of transmission assembly 3, whereby again, elements already described in detail above are provided with the same reference symbols. With regard to the representation in FIG. 8, it should still be noted that the designation “LS” stands for a helical outside gearing with a left pitch, the designation “RS” stands for a helical outside gearing with a right pitch, and the designation “GV” stands for a straight outside gearing. As a person skilled in the art recognizes, it is not absolutely necessary to provide a complementary helical gearing RS-LS in the region of gear wheels 5b and 7.5p, but it is advantageous for transferring higher torques, because power take-offs 7.4, 7.3, and 7.1 are provided with torque by way of the gear wheel 7.5q, whereby at power take-off 7.4, in particular, significant deformation work must be performed, in practice, making a correspondingly high torque necessary. Furthermore, the axial forces of gear wheel pairings 5a-7.9a, 5a-7.5, 5b-7.5p partly cancel one another out as a result.

FIG. 9 represents the coupling conditions within transmission assembly 3 once again, alternatively, in a schematic side view, whereby in the present case, the individual gear wheels for the transfer of torque are shown by means of dot-dash circles. As a person skilled in the art recognizes, it can occur, in the case of the representation selected for FIG. 9, that gear wheels are disposed one behind the other.

Drive 5 transfers a certain torque to gear wheel 7.5a of fifth power take-off 7.5 by means of gear wheel 5a. Independent of this transfer, torque is also transferred by way of gear wheel 7.5p and gear wheel 7.5q, from where it is used further to apply torque to power take-offs 7.4, 7.3, and 7.1, whereby the transfer takes place between gear wheels 7.3a and 7.1a of power take-offs 7.3 and 7.1, circumventing power take-off 7.2, by means of another gear wheel 7.0a placed in between.

Independently, gear wheel 7.2a of second power take-off 7.2 is driven by way of gear wheel 7.5a, so that second power take-off 7.2 is mechanically independent of power take-offs 7.1 and 7.3-7.5, in this regard.

At the same time, drive 5 also acts on gear wheel 7.9a of ninth power take-off 7.9, by way of gear wheel 5a, and from there, by way of additional gear wheel 7.9a′, onto the other power take-offs 7.6-7.8 and 7.10-7.13, respectively, one after the other, which are thereby coupled with one another in groups, just like power take-offs 7.1, 7.3, and 7.4. In contrast, power take-offs 7.2 and 7.5 are mechanically independent, so that here, torque monitoring to prevent an overload can be carried out, according to the invention.

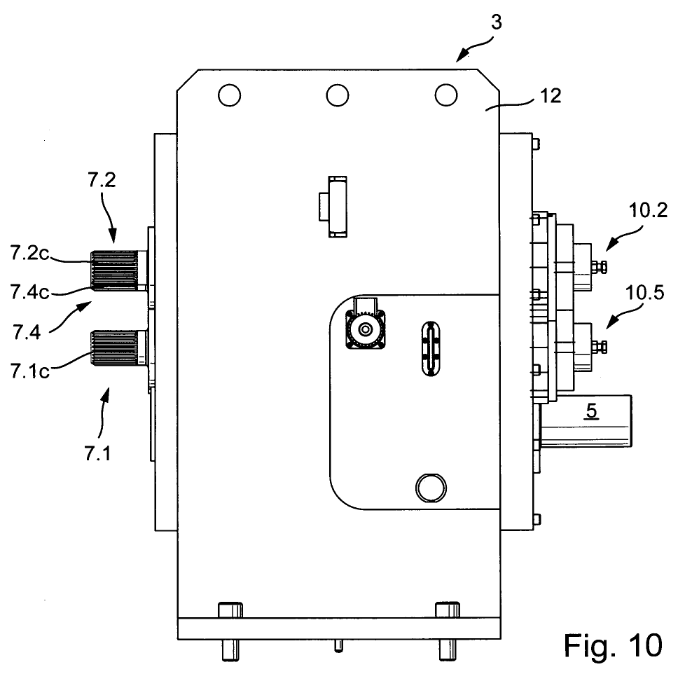

In conclusion, FIG. 10 shows a side view of transmission assembly 3 according to the invention, whereby again, designated elements have the same reference symbols as in the figures described in greater detail above.

Accordingly, although several embodiments of the present invention have been shown and described, it is apparent that many changes and modifications may be made thereunto without departing from the spirit and scope of the invention.

What is claimed is:

1. A transmission assembly for a straightening machine comprising:
(a) at least one drive;
(b) a plurality of power take-offs effectively connected with the drive for a transfer of torque; and
(c) a torque monitoring device;
wherein at least one power take-off is coupled with the torque monitoring device independent of other power take-offs of said plurality of take-offs to monitor a power take-off moment in effect at said at least one power take-off; and
wherein said torque monitoring device outputs a control signal as a function of a result of monitoring said power take-off moment.

2. The transmission assembly according to claim 1, further comprising an overriding drive unit, wherein the control signal is a shutdown signal for said overriding drive unit if the result of monitoring the power take-off moment indicates that a predetermined limit value has been exceeded.

3. The transmission assembly according to claim 2, further comprising at least one torque transfer mechanism coupled with said at least one power take-off, wherein the predetermined limit value comprises a load limit value of said at least one transfer mechanism.

4. The transmission assembly according to claim 3, wherein the torque transfer mechanism comprises an articulated shaft.

5. The transmission assembly according to claim 1, wherein said at least one power take-off has a measurement power take-off shaft mounted to be movable in an axial direction as a function of the power take-off moment in effect, and wherein axial movement of the measurement power take-off shaft is a measure for an effective power take-off moment.

6. The transmission assembly according to claim 5, further comprising a plurality of roller bearings for supporting the measurement power take-off shaft.

7. The transmission assembly according to claim 6, wherein said plurality of roller bearings comprises an axial bearing combined with a radial bearing independent of the axial bearing.

8. The transmission assembly according to claim 5, wherein the measurement power take-off shaft is disposed as an inside shaft in a hollow shaft coupled both with the drive and with other power take-offs of the plurality of power take-offs for a transfer of torque.

9. The transmission assembly according to claim 5, wherein the axial movement of the measurement power take-off shaft is brought about by interaction of a first helically geared gear wheel disposed on the measurement power take-off shaft with a second helically geared gear wheel coupled with the drive, said first helically geared gear wheel having a first pitch direction and said second helically geared gear wheel having a second pitch direction complementary to the first pitch direction.

10. The transmission assembly according to claim 5, wherein the measurement power take-off shaft is directly coupled with the drive.

11. The transmission assembly according to claim 5, wherein no further power take-off shafts are coupled with the measurement power take-off shaft.

12. The transmission assembly according to claim 5, wherein the measurement power take-off shaft is disposed offset relative to a plane that contains the other power take-off shafts.

13. The transmission assembly according to claim 12, wherein the measurement power take-off shaft is offset parallel to said plane.

14. The transmission assembly according to claim 1, wherein the torque monitoring device comprises a pressure sensor.

15. The transmission assembly according to claim 14, wherein the pressure sensor comprises a load cell for generating the control signal.

16. A straightening machine for straightening a plate or strip of material comprising:
(a) a plurality of straightening rollers for straightening the material conveyed between the straightening rollers;
(b) a torque transfer mechanism driving the plurality of straightening rollers; and
(c) a transmission assembly comprising at least one drive, a plurality of power take-offs effectively connected with the drive for a transfer of torque, and a torque monitoring device;
wherein said torque transfer mechanism is connected with said transmission assembly;
wherein at least one power take-off is coupled with the torque monitoring device independent of other power take-offs of said plurality of take-offs to monitor a power take-off moment in effect at said at least one power take-off; and
wherein said torque monitoring device outputs a control signal as function of a result of monitoring said power take-off moment.

17. The straightening machine according to claim 16, wherein the torque transfer mechanism comprises a plurality of articulated shafts.

18. The straightening machine according to claim 16, further comprising a drive unit coupled with the transmission assembly and controlled by the control signal generated by the transmission assembly.

19. The straightening machine according to claim 16, wherein a power take-off shaft corresponding to said at least one power take-off is a measurement power take-off shaft, wherein the straightening rollers are arranged in groups, the rollers within a respective group having parallel roller axes within the group, wherein the roller axes of a first group of straightening rollers are disposed substantially in a first common plane and the roller axes of a second group of straightening rollers is disposed in a second common plane, and wherein an n^{th} straightening roller of the plurality of straightening rollers in a transport direction of the material to be straightened is driven by said measurement power take-off shaft.

20. The straightening machine according to claim 19, wherein n=2 or n=2 and 5, or n=3.

21. The straightening machine according to claim 19, wherein an m^{th} straightening roller in the transport direction of the material to be straightened is disposed offset relative to the straightening rollers of the first group.

22. The straightening machine according to claim 21, wherein the m^{th} straightening roller is offset parallel to the straightening rollers of the first group.

23. The straightening machine according to claim 21, wherein m=2.
